(19) United States
(12) Patent Application Publication
(10) Pub. No.: US 2026/0045082 A1
(43) Pub. Date: Feb. 12, 2026

(54) DEEP LEARNING HIGH RESOLUTION LAND COVER

(71) Applicant: VANTOR INC., Westminster, CO (US)

(72) Inventors: Levi Madenberg, Westminster, CO (US); Collin Kindrom, Westminster, CO (US); Francois Garriet Smith, Westminster, CO (US)

(21) Appl. No.: 18/796,188

(22) Filed: Aug. 6, 2024

(51) Int. Cl. G06V 20/13; G06T 11/40; G06V 10/764; G06V 10/82

(52) U.S. Cl. CPC G06V 20/13; G06T 11/40; G06V 10/765; G06V 10/82

(57) ABSTRACT

A method for performing land classification operations, the method can comprise receiving, by one or more servers, a plurality of High Resolution Land Cover (“HRLC”) final land cover layers; training, by one or more servers, a model using the plurality of HRLC final land cover layers to form a trained deep learning HRLC (“DL-HRLC”) model; and transferring, by the one or more servers, the trained DL-HRLC model for land cover prediction, wherein a land cover inference engine of the trained DL-HRLC model classifies a single image, which comprises a plurality of pixels, to generate an output land cover layer prediction.

### FIELD

This application generally relates to automated generation of high-resolution land cover, and more particularly to a method of generating deep learning-based high resolution land cover.

### BACKGROUND

Satellite images are images of Earth collected by imaging satellites operated by governments and businesses around the world. Satellite imaging companies sell images by licensing them to governments and businesses. Satellite images have many applications in meteorology, oceanography, fishing, agriculture, biodiversity conservation, forestry, landscape, geology, cartography, regional planning, and education. Images may be in visible colors and in other spectra. There are also elevation maps, usually made by radar images, LiDAR data, or optical image pairs. Image interpretation and analysis of satellite imagery may be conducted using software.

Training prediction of land cover based on satellite images can utilize a significant amount of data and include a significant number of independent variables to produce accurate predications at high resolution. Accordingly, machine learning models that produce accurate predictions with less data may be desirable.

### SUMMARY

Disclosed herein is a method for performing land classification operations. In various embodiments, the method comprises: receiving, by one or more servers, a plurality of High Resolution Land Cover (“HRLC”) final land cover layers; training, by one or more servers, a model using the plurality of HRLC final land cover layers to form a trained deep learning HRLC (“DL-HRLC”) model; and transferring, by the one or more servers, the trained DL-HRLC model for land cover prediction, wherein a land cover inference engine of the trained DL-HRLC model classifies each pixel, of a plurality of pixels, in a single image, to generate an output land cover layer prediction.

In various embodiments, the output land cover layer comprises 14 classes.

In various embodiments, the training of the model further comprises: creating, by the one or more servers, a set of independent variables based on two or more images; and using, by the one or more servers, the plurality of HRLC final land cover layers to calibrate weights for each independent variable. In various embodiments, the land cover inference engine uses the same set of independent variables and the respective calibrated weights for each of the independent variables to predict a class for each pixel of the plurality of pixels.

In various embodiments, the method further comprises transferring, by the one or more servers, the model to images from a geographic location where the model was not trained.

In various embodiments, both training and transferring the model comprises: receiving, by the one or more servers, a first image of a scene; receiving, by the one or more servers, a plurality of second images of the scene taken over a period of time, wherein the plurality of second images are taken at a relatively lower resolution than the first image; performing, by the one or more servers, a plurality of transformations on the first image; performing, by the one or more servers, a plurality of transformations on the plurality of second images; and creating, by the one or more servers, a temporal stack layer for a plurality of temporal statistics for each of the plurality of transformations on the plurality of second images, the output land cover layer comprising a plurality of classifications.

In various embodiments, the method further comprises post processing, by the one or more servers, post-classification ruleset correction (PCR) of the output land cover layer.

In various embodiments, the method further comprises post processing, by the one or more servers, comprising post-classification ruleset correction via a fuzzy classifier of the output land cover layer. In various embodiments, the fuzzy classifier is configured to receive fuzzy classifier inputs comprising at least one of: raw land cover from the model, NDVI and NDWI from a first image, segment clumps, P3D classification (or some buildings and roads layer), a cloud mask, and a floodplain mask; and wherein the fuzzy classifier is configured to generate a refined land cover layer based on the fuzzy classifier inputs and based on the output land cover layer. In various embodiments, the fuzzy classifier performs fuzzy classification by: testing the output land cover layer using a ruleset that leverages a subset of the independent variables to determine if each classified pixel fails or passes the ruleset test; wherein when the classified pixel fails the ruleset test, a second layer produced by the CNN classifier may be run through the same ruleset; wherein when the classified pixel passes the ruleset test with the second land cover layer, and fails the test with the first layer, the pixels from the second classification may be used in a final refined land cover layer.

In various embodiments, the PCR further comprises intersect object learning classification.

In various embodiments, the independent variables further comprise a source image layer.

In various embodiments, the method further comprises: formatting, by the one or more servers, the images; and delivering, by the one or more servers, the images, whereby the images are delivered with 14 classes at 2m resolution.

In various embodiments, a number of independent variables are used to train the model, wherein the number is greater than four, and wherein the model is configured to be trained without over-fitting.

In various embodiments, transferring the model comprises performing, by the one or more servers, a plurality of transformations including at least one of: a Normalized Difference Vegetation Index (NDVI) transformation; a Normalized Difference Wetness Index (NDWI) transformation; a Modified Soil-Adjusted Vegetation Index (MSAVI) transformation; a Tasseled Cap band 1 transformation; a Tasseled Cap band 2 transformation; a Tasseled Cap band 3 transformation; wherein the plurality of temporal statistics comprise at least one of minimum, maximum, mean, median, standard deviation, and range; and wherein the plurality of classifications comprise at least one of deciduous trees, evergreen trees, scrub, grass, bare, built-up/structures, agriculture dry, agriculture wet, wetland, mangrove, water, snow/ice, clouds, and other impervious surface.

In various embodiments, during training the model, the model is trained with inputs that simulate atmospheric degradation haze/fog.

In various embodiments, transferring the model further comprises running the model on a Convolutional Neural Network (“CNN”) comprising an Xunet CNN, wherein the model comprises a ‘reduced’ receptive field, a source imagery mask layer, a vector layer, “fog” data augmentations, and brightness/contrast augmentation.

In various embodiments, transferring the model further comprises using a high-res Digital Surface Model (“DSM”) as independent variables in a classifier, and from the high-res DSM produce a floodplain mask.

In various embodiments, generating HRLC outputs comprises: receiving, by the one or more servers, a first image of a scene; receiving, by the one or more servers, a plurality of second images of the scene taken over a period of time, wherein the plurality of second images are taken at a relatively lower resolution than the first image; performing, by the one or more servers, segmentation on the first image; performing, by the one or more servers, a plurality of transformations on the plurality of second images; and creating, by the one or more servers, a temporal stack layer for a plurality of temporal statistics for each of the plurality of transformations on the plurality of second images.

### BRIEF DESCRIPTION OF THE DRAWINGS

The subject matter of the present disclosure is particularly pointed out and distinctly claimed in the concluding portion of the specification. A more complete understanding of the present disclosure may be obtained by referring to the detailed description and claims when considered in connection with the drawing figures, wherein like numerals denote like elements. Each of the various Figures and components may be in accordance with various embodiments of the disclosure.

FIG. 1 is an example system for training and transferring a model for generating deep learning high resolution land cover, in accordance with various embodiments.

FIG. 2 is a block diagram illustrating an example method for deep learning high resolution land cover, in accordance with various embodiments.

FIG. 3 is a block diagram illustrating another example method for deep learning high resolution land cover, in accordance with various embodiments.

### DETAILED DESCRIPTION

Land cover may comprise the physical material at the surface of Earth. Land covers include grass, asphalt, trees, bare ground, and water for example. Land cover maps may be tools that provide information about the Earth's land use and cover patterns. Land cover maps may aid policy development, urban planning, and forest and agricultural monitoring.

Disclosed herein is a land classification method for predicting land cover over a region (e.g., a local region, a national region, the world, or any other region that may be readily apparent to one skilled in the art). In various embodiments, the land classification method comprises utilization of a deep learning high resolution land cover (DL-HRLC) model. In various embodiments, the DL-HRLC model is configured to receive a set of inputs. In various embodiments, the set of inputs can each be an output from a High-Resolution Land Cover (HRLC) model. In this regard, the HRLC model can have a first target objective (e.g., may comprise an automated process for producing), for example, 14-class land cover datasets using a high-resolution image, a set of medium-resolution image, and a manually derived training dataset as inputs. HRLC may allow for efficiently and accurately producing, for example, 2m resolution land cover.

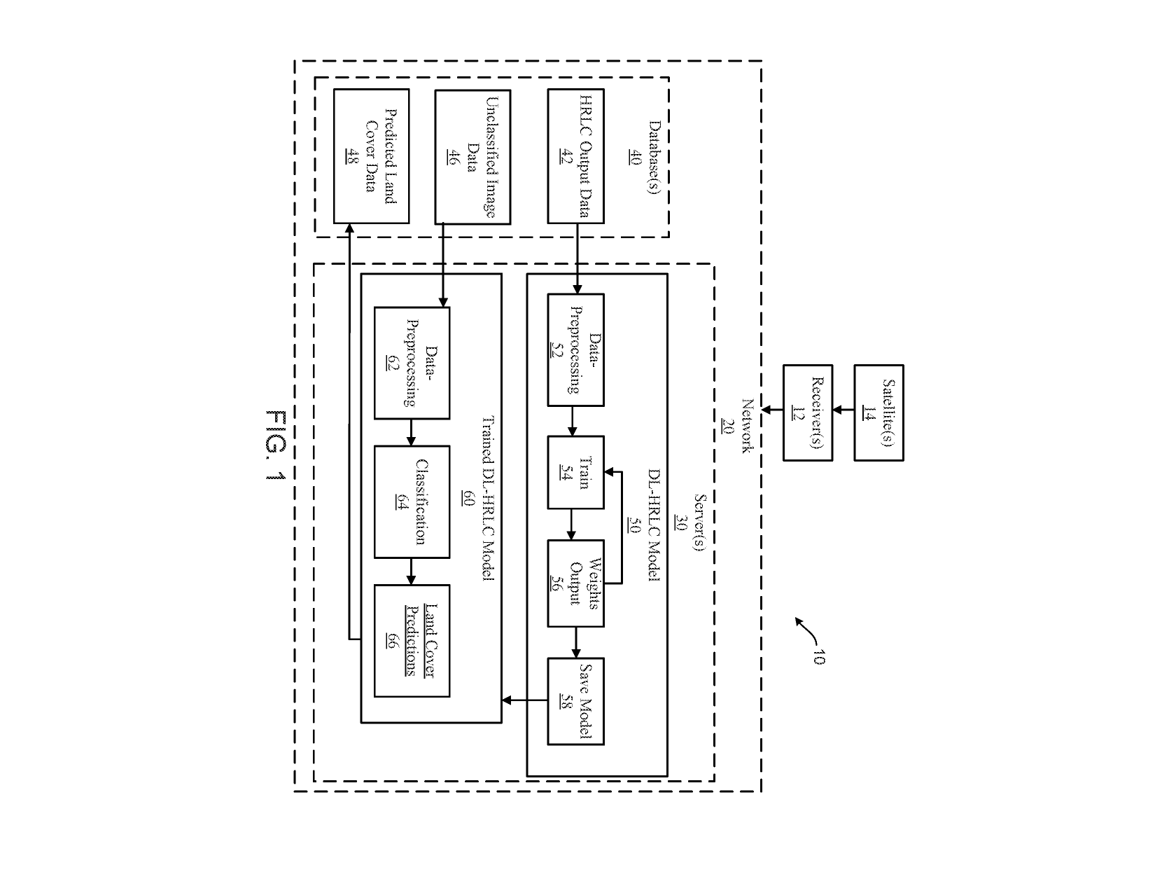

Referring now to FIG. 1, a system 10 for generating a trained model and transferring the trained model is illustrated, in accordance with various embodiments. In various embodiments, the system 10 comprises a network 20, one or more servers 30, and one or more databases 40. The network 20 can be in electronic communication with one or more satellites 14 (e.g., via one or more receivers 12). Each of the one or more satellites 14 is configured to capture image data for various geographical regions of the earth. “Image data” as referred to herein includes one or more satellite images collected by imaging satellites (i.e., the one or more satellites 14 of system 10). In this regard, the image data can include numerous images of different, or the same resolution, in accordance with various embodiments.

In various embodiments, the one or more satellites 14 are configured to transfer the image data to the system 10 via one or more receivers 12. In this regard, each of the one or more satellites 14 is configured to transmit the image data (e.g., continuously, continually, periodically, or intermittently) from the one or more satellites 14 to the one or more databases 40. The one or more databases 40 can store the image data for use in training an HRLC model, the DL-HRLC model 50 and/or for transferring the trained DL-HRLC model 60 as described further herein.

In various embodiments, the one or more servers 30 have software, hardware, and management procedures that communicate with the one or more databases 40. In various embodiments, the one or more servers 30 may include application servers (e.g., Azure App Service, WEBSPHERE®, WEBLOGIC®, JBOSS®, POSTGRES PLUS ADVANCED SERVER®, etc.). In various embodiments, the one or more servers 30 may include web servers (e.g., Apache, IIS, GOOGLE® Web Server, SUN JAVA® System Web Server, JAVA® Virtual Machine running on LINUX® or WINDOWS® operating systems.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, an Android device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet may be contemplated.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

“As used herein, “transmit” may include sending electronic data from one system component to another over a network connection. Additionally, as used herein, “data” may include encompassing information such as commands, queries, files, data for storage, and the like in digital or any other form.

Any databases (e.g., one or more databases 40) discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT Azure Cosmos® or MICROSOFT SQL SERVER® by MICROSOFT® Corporation (Redmond, Washington), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

In various embodiments, the one or more servers 30 include one or more machine learning models (e.g., a DL-HRLC model 50, a trained DL-HRLC model 60). In various embodiments, the one or more servers 30 can also include the HRLC model that produces an output (e.g., HRLC output data 42) that is input into the DL-HRLC model 50. However, the present disclosure is not limited in this regard. For example, the HRLC model can be a model of a separate system that is independent of system 10 and would still be within the scope of this disclosure.

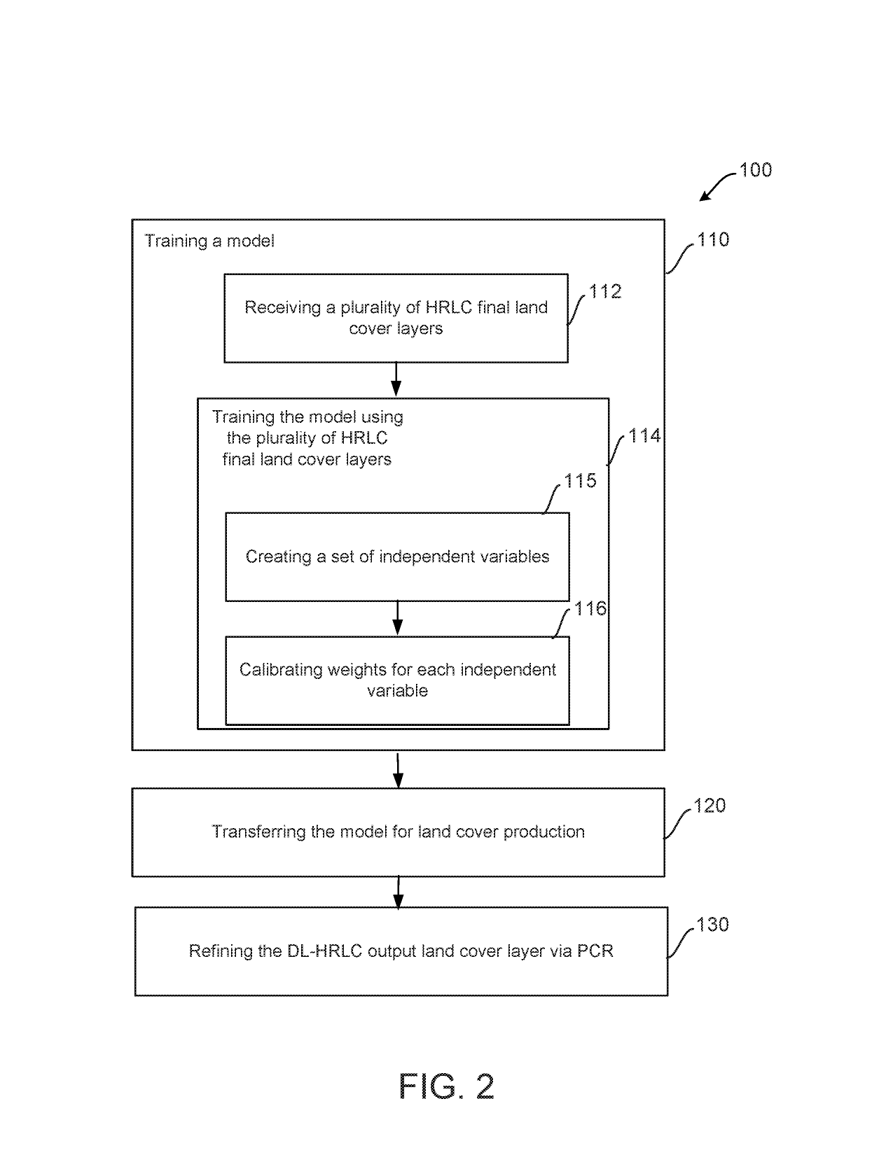

With combined reference now to FIGS. 1 and 2, in various embodiments, the one or more servers 30 are configured to perform a land classification method 100 (e.g., via the DL-HRLC model 50 and/or the trained DL-HRLC model 60). The method 100 may be described as a deep learning high resolution land cover (DL-HRLC) method. In various embodiments, the land classification method may comprise: training a model (e.g., training the trained DL-HRLC Model 60 via the DL-HRLC model 50) (step 110) and transferring the model (e.g., the saved model 58 that is output from the DL-HRLC model 50) (step 120) for land cover prediction (e.g., for generating land cover predictions 66 from unclassified image data 46). In this regard, the method 100 can produce a trained DL-HRLC model 60 that utilizes a fully automated (or at least semi-automated process) for producing a predicted land cover (e.g., predicted land cover data 48).

In various embodiments, to train the DL-HRLC model 50, an HRLC output data (or a set of data from the HRLC output data) is input into the DL-HRLC model 50. Accordingly, because training the DL-HRLC model involves receiving the outputs of an HRLC process to train the DL-HRLC model 50, the HRLC outputs are briefly described, now. An HRLC final land cover layer may be described as an HRLC output. In various embodiments, an HRLC final land cover layer may comprise a land cover layer generated by an HRLC process and may optionally include any suitable post processing to the output of the HRLC process. For example, a trained HRLC model can include manual adjustments (or modifications) that were made during training of the HRLC model. These adjustments (or modifications) can be included in the HRLC output data 42 and be utilized in training the DL-HRLC model 50 as described further herein. More specifically, the post processing may include, for example, editing, post-classification ruleset correction, atmospheric correction, temporal signature generation of multitemporal images, and/or the like, to refine the raw classified output of the HRLC process. Thus, the HRLC final land cover layer may be merely the data outputs of the HRLC process, or may comprise the data outputs of the HRLC process that have been manually edited or otherwise refined to create the HRLC final land cover layer (i.e., a training data set).

In various embodiments, the HRLC final land cover layer is a 14-class land cover layer. However, the HRLC final land cover layer may comprise any suitable number of classes. In various embodiments, a 14-class land cover can correspond to a standard number of different classifications used in the industry.

In various embodiments, a plurality of HRLC final land cover layers may be generated by running HRLC on a number of different geographic portions of the earth. By different geographic portions of the earth, it is meant that the imaged portion is from locations that are at great distances from each other, are very different in the type of ground cover that is prevalent in the imaged location, and/or the like. Stated another way, in order to achieve a sufficient diversity in the training data set, the different geographic portions of the earth represent different biomes comprising different assemblages of land cover features. For example, the images may be from a forest, a coastal town, a densely populated city, an agricultural area, wetlands, arid locations, humid locations, rain forests, areas of different cultures, and/or different political/country locations. In various embodiments, these different geographic portions are denoted a first set of different geographic portions. These first set of different geographic portions are used in generating the plurality of HRLC final land cover layers (e.g., the HRLC output data), which are subsequently used in training the DL-HRLC model 50 (step 110).

In further example embodiments, each HRLC final land cover layer in the HRLC output data 42 is based on a large number of independent variables. For example, each HRLC land cover layer may be based on between 100 and 250 independent variables, or between 150 and 200 independent variables, or approximately 172 independent variables. However, in other example embodiments, any suitable number of independent variables may be used in generation of the HRLC final land cover layer.

In various embodiments, training the model (step 110) may comprise receiving a plurality of HRLC final land cover layers from the HRLC output data 42 (step 112) and training the model (e.g., a DL-HRLC model 50) using the plurality of HRLC final land cover layers (step 114). Stated another way, in various embodiments, the HRLC outputs (e.g., HRLC output data 42) are used to train the model (step 110), or the HRLC outputs (e.g., HRLC output data 42) are the training dataset and predictive output of the model (e.g., DL-HRLC model 50).

In various embodiments, training the model (e.g., the DL-HRLC model 50) in step 110 may further comprise: creating a set of independent variables (step 115) based on two or more images (e.g., data pre-processing 52). For example, the two or more images may comprise a high-resolution image and a medium to lower resolution image. In various embodiments, the high-resolution image is relatively higher in resolution than the medium to lower resolution image. In various embodiments, the high-resolution image is an image with a resolution equal to or higher than two-meter (2m) resolution. In various embodiments, the high-resolution image is an image with a resolution of between 2m and 10m. In another example embodiment, the medium to lower low resolution image is an image having a resolution of 10m to 60m. Moreover, any suitable resolution ranges may be used in accordance with the principles described herein.

In various embodiments, the independent variables further comprise four different multispectral bands of the high resolution image. In various embodiments, the independent variables further comprise derived layers based on those four images. For example, mathematical functions may be performed on the original image or on the four multispectral band images, such as dividing the near-infrared band image by the green band image, multiplying an image by a coefficient, and/or any suitable mathematical function.

In accordance with more specific example embodiments, the DL-HRLC independent variables comprise: a set of the reference image (e.g., four reference images), derived indices, temporal statistical layers, and terrain layers. In various embodiments, the DL-HRLC independent variables comprise 43 independent variables, namely: target image – 4 bands, High-res urban texture, MSAVI (built-in), NDWI (built-in), TexVeg, Source Image Thematic Layer, S-2 Tcap temporal bright – 6 bands, S-2 Tcap temporal wet – 6 bands, S-2 Tcap temporal green – 6 bands, S-2 MSAVI temporal – 6 bands, S-2 NDWI temporal – 6 bands, P3DR DTM, P3DR DHM, high-res NDVI, and the pan-band. In other example embodiments, the independent variables may comprise a selection from among those listed here, or from similar independent variables.

Thus, in various embodiments, a significantly fewer number of independent variables are used to generate the DL-HRLC model 50 than are used to generate the HRLC outputs. For example, in contrast to the 172 independent variables that are used in generating the HRLC outputs, training the DL-HRLC model 50 can use 43 independent variables to train the DL-HRLC model 50. These 43 independent variables may comprise a subset of the 172 independent variables used to create the HRLC output, with the difference being that DL-HRLC does not use the segmented variables used in HRLC. In various embodiments of the present disclosure, training the model comprises using a number of independent variables, the number being greater than 4, greater than 10, greater than 20, the number being 43, and/or the like. In various embodiments, the number of independent variables can comprise between 4 independent variables and 100 independent variables, or between 10 independent variables and 90 independent variables, or between 30 independent variables and 50 independent variables. In various embodiments, the number of independent variables used in training HRLC model can be at least twice as many as the DL-HRLC model 50, or at least three times as many as the DL-HRLC model 50.

In various embodiments, the independent variables further comprise a source image layer. The source image layer may comprise a thematic layer attributed by the component scenes that make up a mosaic. The mosaic may comprise, for example, a 15 minute x 15 minute tile (or other suitably dimensioned tile). In various embodiments, the mosaic comprises the meta data for an area, wherein multiple images overlap that area. The meta data may, for example, comprise the angle of the sun, the satellite location, etc., for each image overlapping the area. The source image layer may act as a metadata file but also as strata for the classifier. Thus, in various embodiments, the model (e.g., the DL-HRLC model 50) is informed by this meta data which can vary over space. Stated another way, the method uses strata in a CNN to generate land cover predictions.

In various embodiments, the DL-HRLC model 50 is configured to have “fog” data augmentations, and/or brightness/contrast augmentations. In various embodiments, the DL-HRLC model 50 is trained with inputs that simulate atmospheric degradation (denser atmospheric obstruction). The atmospheric degradation may comprise one or more of fog, haze, clouds, and/or the like. In various embodiments, a first image, e.g., a multispectral image, may be replaced with a degraded first image (e.g., the first image blurred with fog, rain, mist, falling snow, and / or the like). This helps the DL-HRLC model 50 be trained for such future situations. Similarly, the DL-HRLC model 50 may be trained with replacement images that are darkened (increased contrast/brightness) or lightened (decreased contrast/brightness) versions of the respective multispectral image input. In other words, the ‘augmentations’ may comprise replacement images derived from respective multispectral image input similar to how other metrics are derived, and provided to the model as image inputs for training along with good quality HRLC outputs so the model can learn through these degradations.

In various embodiments, training the model (e.g., the DL-HRLC model 50) further comprises: using the HRLC outputs (e.g., from the HRLC output data 42) to calibrate weights for each independent variable (e.g., weight outputs 56 in the DL-HRLC model 50) (step 116). As noted above, the HRLC final outputs may be merely the data outputs of the HRLC process, or may comprise the data outputs of the HRLC process that have been manually edited to create the training data set. In various embodiments, the weights are calibrated through use of CNN training.

In various embodiments, the DL-HRLC model 50 is trained using HRLC final land cover layers that were generated from images taken of different geographic portions of the earth. In various embodiments, the DL-HRLC model may be trained using HRLC final land cover layers based on at least three or more of the different images taken at different geographic portions of the earth. By different geographic portions of the earth, it is meant that the imaged portion is from locations that are at great distances from each other, are very different in the type of ground cover that is prevalent in the imaged location, and/or the like. Stated another way, in order to achieve a sufficient diversity in the training data set, the different geographic portions of the earth represent different biomes comprising different assemblages of land cover features. For example, the images may be from a forest, a coastal town, a densely populated city, an agricultural area, wetlands, arid locations, humid locations, rain forests, areas of different cultures, and/or different political/country locations. In various embodiments, these different geographic portions are denoted a first set of different geographic portions. These first set of different geographic portions are used in generating the plurality of HRLC final land cover layers, which are used in training the DL-HRLC model (step 110).

In various embodiments, calibrating the weights in step 116 of the training the DL-HRLC model 50 from step 110 of method 100 can be an iterative process. For example, a first set of HRLC output data 42 (e.g., 10 images from a 100 image set) can be input into the DL-HRLC model 50 (e.g., for data pre-processing). The DL-HRLC model 50 can then be trained in training module 54 with the first set of the HRLC output data 42 based on a training objective (i.e., correlating an input unclassified image to a predicted land cover). In this regard, training the DL-HRLC model 50 can occur without overfitting. Overfitting is a modeling error that can occur in machine learning where model training focuses on certain information in a training data set that causes error when applied to data outside the training data set. This can be more problematic where the training data involves a large number of independent variables (i.e., where there is more data to ‘throw-off’ the training).

In various embodiments, overfitting is avoided here by training progressively with intermediate evaluations and training input. For example, a first group of X maps may be used to train the DL-HRLC model 50 (e.g., a first set of the HRLC output data 42), and the training in training module 54 may generate two sets of weights as weights output 56. Then, the performance of each set of weights can be evaluated (e.g., by running the trained DL-HRLC model 60 with the weights that were output in weights output 56), and a person may choose which of the two sets of weights is preferred based on the land cover predictions 66 that each of the set of weights produces. The preferred set of weights is then used (i.e., provided as a variable for the training module 54) for training with a second group of X maps (e.g., a second set of the HRLC output data 42). This pattern may be repeated as desired and/or until a point of diminishing returns is reached. In this example embodiment, the method 100 is configured to train the model using the same number of independent variables for each group of X maps (e.g., five maps at a time, 10 maps at a time, or any other number of maps at a given time). Moreover, the method may be configured to train the DL-HRLC model 50 using the same number of independent variables and same independent variables as subsequently used in transferring the model in step 120.

In various embodiments, the training in training module 54 is configured to output one set of trained weights when the loss rate is at its lowest (the ‘lowest loss rate weights’), and another set of trained weights at the end of the training period (the ‘final weights’). If 10 maps were used, in various embodiments, the loss rate may be lowest after the first 8 maps, which generates the first weight, and the training may continue through the 10^{th} map to generate the second weight. The training process may be configured to perform the training on the X maps, automatically (without human intervention), before stopping and enabling a manual decision as to which of the two weights are desired. In this manual intermediate step, the trained DL-HRLC model 60 is used in an automated way to generate first and second outputs (e.g., land cover predictions 66), corresponding to the first and second weights. Then a person, production team, client or the like, can look at the first and second outputs and choose the one they prefer. The preference may indicate a desire to improve the land classification for any suitable reason including a desire to emphasize the accuracy of the model with a particular geographic area, or on a particularly important land cover class for that client. The selection of the first or second output then causes the corresponding first or second weights to be used for training a next set of X maps. This process may repeat as desired until the DL-HRLC model 50 is sufficiently trained to be used. In various embodiments, this intermediate training evaluation enables the DL-HRLC model 50 to be trained based on what type of edits are most important. In various embodiments, if overfitting is detected, the training in training module 54 is configured to end early.

In various embodiments, the training in training module 54 is divided into 10 groups (or training sessions) or in other words, the training data was divided into 10 groups of training data for sequential use. In this example embodiment, after a group of training data is processed, output results are generated, and the process stops to evaluate the results (comparing results of both weights (lowest loss rate weights, final weights)) over different geographical test sites. Next, the training continues with the next group of training data (e.g., a subsequent set of the HRLC output data 42), but using the preferred weights for the immediately prior group. This solution may be particularly applicable when a large amount of training data (i.e., a large number of map mosaics) is available, as well as when there is a high degree of interrelationships between the independent variables.

In various embodiments, the training of the DL-HRLC model 50 can be semi-automated, with the only human intervention being analyzing the respective weights output for training the subsequent set of HRLC output data 42. In various embodiments, the trained DL-HRLC model 60 that is generated from step 110 of method 100 can be fully automated. For example, once the weights have been calibrated in the training step 110, the trained DL-HRLC model 60 can be run with unclassified image data 46 in a fully autonomous manner to generate land cover predictions 66 and transmit the predicted land cover data 48 to the one or more databases 40 for production and/or use, in accordance with various embodiments.

In various embodiments, the trained DL-HRLC model 60 is a trained universal unet model. In various embodiments, the model is configured to have a ‘reduced’ receptive field.

In further embodiments, transferring the DL-HRLC model 50 (e.g., saving model 58 that is generated from training the DL-HRLC model 50) (step 120) comprises producing land cover (e.g., generating land cover predictions 66 from unclassified image data 46 that is pre-processed in data-preprocessing and classified in classification module 64). In various embodiments, transferring the DL-HRLC model 50 means using the trained DL-HRLC model 60 to classify images taken of a geographic location (e.g., unclassified image data 46) for which the trained DL-HRLC model 60 was not trained. Thus, transferring the DL-HRLC model 50 facilitates producing global landcover with a trained DL-HRLC model 60 that is trained on a limited number of geographic locations.

In various embodiments, the land cover production may be made by an inference engine that is configured to classify a single image in classification module 64, comprising a plurality of pixels, to generate an output land cover layer having a plurality of classes. Stated another way, the classification module 64 can comprise the inference engine. In various embodiments, the inference engine of the classification module 64 may be configured to classify a mosaic of images. The inference engine may be configured to classify the image or mosaic of images based on the independent variables and their associated weights (e.g., a final weight selected from the weights output 56 generated from training the DL-HRLC model 50), as established during the model training (step 110). In various embodiments, the inference engine uses the same set of independent variables and the respective calibrated weights, for each of the independent variables, to predict a class for each pixel of the plurality of pixels, as it used to train the DL-HRLC model 50.

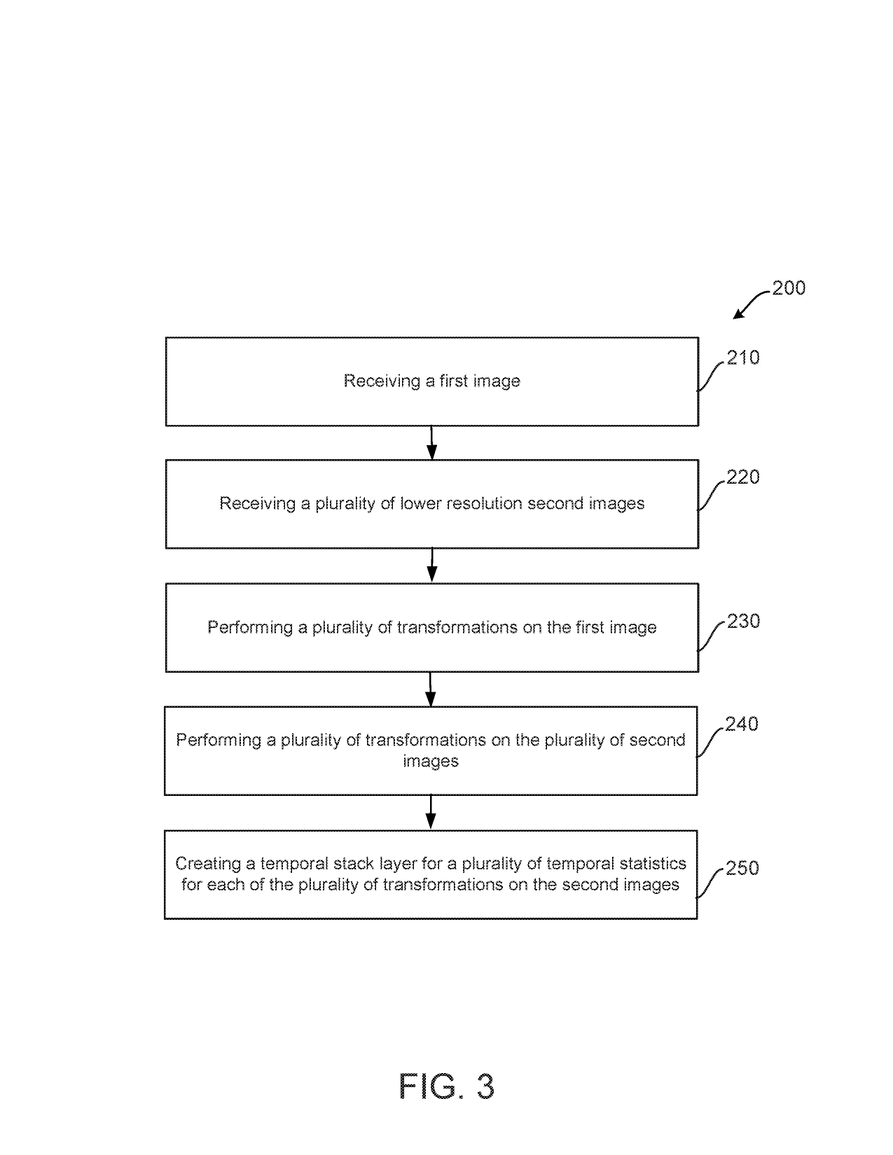

In various embodiments, and with combined reference to FIGS. 1 and 3, both training the DL-HRLC model 50 and transferring the trained DL-HRLC model 60 comprise the following steps: receiving a first image of a scene (e.g., receiving a first image from the HRLC output data 42 for the DL-HRLC model 50 or receiving a first image from unclassified image data 46 for the trained DL-HRLC model 60) (step 210); receiving a plurality of second images of the scene taken over a period of time (e.g., receiving the plurality of second images from the HRLC output data 42 for the DL-HRLC model 50 or receiving the plurality of second images from unclassified image data 46 for the trained DL-HRLC model 60) (step 220), wherein the plurality of second images are taken at a relatively lower resolution than the first image; performing a plurality of transformations on the first image (step 230); performing a plurality of transformations on the plurality of second images (step 240); and creating a temporal stack layer for a plurality of temporal statistics for each of the plurality of transformations on the plurality of second images (step 250). These steps are performed in the data pre-processing 52 for the DL-HRLC model 50 and the data-preprocessing 62 for the trained DL-HRLC model 60 and used to produce the independent variables that are used both in training the model as well as transferring the model (to areas that have not been used to train the model). In various embodiments, the first image of the scene may comprise a target image (4-band).

In accordance with various example embodiments, transferring the model comprises a plurality of transformations including at least one of: a Normalized Difference Vegetation Index (NDVI) transformation; a Normalized Difference Wetness Index (NDWI) transformation; a Modified Soil-Adjusted Vegetation Index (MSAVI) transformation; a Tasseled Cap band 1 transformation; a Tasseled Cap band 2 transformation; a Tasseled Cap band 3 transformation. In various embodiments, the independent variables used when running the model include: 4-band target image, High-res urban texture, MSAVI (built-in), NDWI (built-in), TexVeg, Source Image Thematic Layer, S-2 Tcap temporal bright – 6 bands, S-2 Tcap temporal wet – 6 bands, S-2 Tcap temporal green – 6 bands, S-2 MSAVI temporal – 6 bands, S-2 NDWI temporal – 6 bands, P3DR DTM, P3DR DHM, and individual pan-band.

In various embodiments, transferring the trained DL-HRLC model 60 comprises a plurality of temporal statistics that comprise at least one of: minimum, maximum, mean, median, standard deviation, and range.

In various embodiments, the first image may be a high-resolution image. For example, the first image may have a 2 m/pixel resolution. Moreover, the first image resolution may be any suitably high resolution. In various embodiments, the plurality of second images may be a medium to lower resolution image. For example, the second images may have between 2 m/pixel and 10m/pixel resolution, or between 3m/pixel and 10 m/pixel resolution, or between 5 m/pixel and 10 m/pixel resolution. Moreover, the second images resolution may be any suitable medium to lower resolution.

In various embodiments, performing a plurality of transformations on the first image may comprise transformations such as NDVI, NDWI, TexVeg, urban index, and source image layer. In various embodiments, performing a plurality of transformations on the plurality of second images may comprise transformations such as NDWI, MSAVI, and TCAP.

In various embodiments, creating a temporal stack layer for a plurality of temporal statistics for each of the plurality of transformations on the plurality of second images (step 250) may comprise creating a large number of temporal stack layers equal to the number of temporal statistic x * number of different transformations. In various embodiments, transferring the model further comprises running the model on a Convolutional Neural Network (“CNN”). In various embodiments, the CNN is an Xunet CNN. Moreover, transferring the trained DL-HRLC model 60 may further comprise using a high-resolution Digital Surface Model (“DSM”) as independent variables in the inference engine, and from the DSM producing a floodplain mask.

In various embodiments, a second set of different geographic portions may be used during the transferring the model (step 120). In this example embodiment, this second set of different geographic portions are not the same as the first set of geographic portions used in connection with training the DL-HRLC model 50. Stated in other ways, the first and second sets are images from different geographic locations or are from dissimilar geographic locations.

In various embodiments, DL-HRLC does not use the segmented version of the 10m temporal variables. Accordingly, this is in contrast to HRLC that does use the segmented version of the 10m temporal variables. This difference results in fewer overall independent variables in DL-HRLC than HRLC. Thus, in various embodiments, when the HRLC final land cover layers are used to train a DL-HRLC model 50, that training is based on independent and dependent variables, but once the model is trained, the trained DL-HRLC model 60 can be used (transferred) without use of dependent variables and only a subset of independent variables. Those independent variables used include the same independent variables (the same number and type of independent variables) that were used to create trained the DL-HRLC model 50 but are now used to run the trained DL-HRLC model 60 (transfer the trained DL-HRLC model 60) in other areas (i.e., running the same model produced in one place in another place). Thus, the method 200 is configured to require no additional training when classifying land in new areas where training has not occurred (i.e., when utilizing the classification module 64 of the trained DL-HRLC model 60). This can make land classification highly efficient.

In various embodiments, transferring the model (step 120) may comprise using of subset of the independent variables used in HRLC. For example, the subset of independent variables may comprise the multispectral metrics (i.e. NDVI, Precision3D DTM, etc.). Thus, in various embodiments, transferring the model (step 120) can be implemented without using some of the independent variables used in HRLC. In various embodiments, the HRLC uses a random forest-based inference and the DL-HRLC uses a CNN based inference engine. The difference is that the random forest-based inference in HRLC classifies according to a knowledge base generated through hand labeling of a subset of the pixels of the target scene, but in the CNN based inference engine in DL-HRLC the knowledge base is comprised of the weights of the independent variables and it is therefore unnecessary to hand-label a subset of the target scene. Stated another way, in various embodiments, the trained DL-HRLC model 60 is calibrated for and prior to the inference step.

Thus, in accordance with various example embodiments, the land classification method 100 from FIG. 2 represents a stacked model approach, where DL-HRLC is configured to predict HRLC. In ‘predicting HRLC’, the method is configured to predict a land cover class for each pixel in land cover layer (e.g., land cover predictions 66). In this example embodiment, predicting a pixel may be called semantic segmentation.

In various example embodiments, the resolution of the images used to train the model (e.g., to train the DL-HRLC model 50) are the same resolution of the images being transferred (e.g., in transferring the trained DL-HRLC model 60) in this method. This is the case because changing the resolution will change the weights determined during training. In various embodiments, the training step is configured to look for patterns between the trained model and the images to be analyzed.

In various embodiments, the DL-HRLC output land cover layer may comprise a plurality of classes. The output land cover layer may comprise any suitable number of classes (e.g. the land cover may be a 2-class, 3-class, … or 14-class land cover). However, in various embodiments, the output land cover layer has the same number of classes (and same type of classes) as the HRLC final land cover layers that were used to train the DL-HRLC model 50. In one specific example embodiment, both the DL-HRLC output land cover layer and the HRLC final land cover layers used to train the DL-HRLC model 50 comprise 14-class land cover layers. In various embodiments, the plurality of classifications comprise two or more of the following: deciduous trees, evergreen trees, scrub/shrub, grass, bare, built-up/structures, agriculture dry, agriculture wet, wetland, mangrove, water, snow/ice, clouds, and other impervious surface.

In various embodiments, the training process performed in training module 54 of the DL-HRLC model 50 is configured to selectively dropout certain information from at least one independent variable. For example, the training process may be configured to selectively dropout precision3D data. In a further example embodiment, the training process selectively drops out precision3D data on a periodic basis, such as, for example, every tenth training step. In various embodiments, selective dropout means that while the independent variable ‘channel’ is still used, on one or more training steps, the channel is ‘blank’ or has no data. In this manner, the DL-HRLC model 50 is configured to enhance training for situations where no data is available on that channel with transferring the model.

In various embodiments, the transferring step may further comprise optional additional processing, such as by implementing a rounding process applied to the edges of a moving window within which the DL-HRLC inference occurs, for reducing hardlines between windows, to address the seams or edges between classified tiles or “windows” (e.g., 512x512 pixels). In various embodiments, this may be effected by a rounding process applied to the edges of the window within which the inference engine.

In various embodiments, a source image layer is produced during a mosaic process when creating an input image tile. It is a raster layer in which each pixel corresponds to the image component that makes up the mosaic. One or more images may be used to make up the mosaic. The source image layer contains attributes that correspond to metadata of each component scene. The attributes may include: date of image, scene ID code, sensor elevation and azimuth during image collection, sun elevation and azimuth during image collection. In various embodiments, the source image layer is configured to provide a stratification of the independent variables during machine learning classification, and to be able to automatically run processes on portions of the mosaic differently depending on the different locations and collection parameters of the component scenes.

In various embodiments, the method 100 from FIG. 2 may further comprise post processing classification ruleset (PCR) refinement (step 130) of the DL-HRLC output land cover layer. For example, the post processing may comprise classification ruleset correction via a fuzzy classifier of the output land cover layer. In various embodiments, the fuzzy classifier is configured to receive fuzzy classifier inputs comprising at least one of: raw land cover from the model, NDVI and NDWI from the first image, segment clumps, P3D classification (or some buildings and roads layer), a cloud mask, and a floodplain mask. In various embodiments, the fuzzy classifier is configured to generate a refined land cover layer based on the fuzzy classifier inputs and based on the output land cover layer.

In a further example embodiment, the fuzzy classification further comprise testing the raw automated land cover output from the CNN by using a ruleset that leverages a subset of the independent variables listed above. In cases where a classified pixel fails the ruleset test, a second layer produced by the CNN classifier may be run through the same ruleset. Where the second land cover layer passes and the first land cover layer failed, the pixels from the second classification may be used in the final refined land cover layer. In various embodiments, the second classification layer does not include the 2 urban categories.

In a further example embodiment, another post-classification step in the PCR model may comprise intersecting target-image-derived segments with land cover results from the CNN using a majority function to reduce noise and increase usability (look and feel) of the land cover.

In various embodiments, in accordance with an example embodiment, the raw classification DL-HRLC land cover output may be considered a “pixel-based” approach. In a pixel-based approach the class of each pixel is independently determined. But, in accordance with various optional examples, to create an expected look/feel for the DL-HRLC land cover layers, the raw classification DL-HRLC land cover output can be intersected with pre-determined feature boundaries derived from a segmentation process. In this optional embodiment, the transformation of a DL-HRLC results from a pixel-based process to an object-oriented process occurs during the intersection step in the PCR model. In this example embodiment, the post processed DL-HRLC can be classified as an “object-oriented” classification approach since it includes the intersection of the raw classification.

Furthermore, the example method 100 may further comprise formatting and delivery, whereby the images are delivered with 14 classes at 2m resolution.

In accordance with an example embodiment, generating HRLC outputs comprises: receiving a first image of a scene {e.g. 2m/pixel resolution, a target scene, having target scene resolution}; receiving a plurality of second images of the scene taken over a period of time, wherein the plurality of second images are taken at a relatively lower resolution than the first image; performing segmentation on the first image; performing a plurality of transformations on the plurality of second images {e.g., NDWI, MSAVI, TCAP}; and creating a temporal stack layer for a plurality of temporal statistics for each of the plurality of transformations on the plurality of second images {e.g. to create a large number of temporal stack layers = temporal statistic x * spatial statistic y * number of different transformations}. Nevertheless, other methods of generating HRLC outputs may be used.

We claim:

1. A method for performing land classification operations, the method comprising:
receiving, by one or more servers, a plurality of High Resolution Land Cover (“HRLC”) final land cover layers;
training, by the one or more servers, a model using the plurality of HRLC final land cover layers to form a trained deep learning HRLC (“DL-HRLC”) model; and
transferring, by the one or more servers, the trained DL-HRLC model for land cover prediction, wherein a land cover inference engine of the trained DL-HRLC model classifies each pixel, of a plurality of pixels, in a single image, to generate an output land cover layer prediction.

2. The method of claim 1, wherein the output land cover layer prediction comprises 14 classes.

3. The method of claim 1, wherein training of the model further comprises:
creating, by the one or more servers, a set of independent variables based on two or more images; and
using, by the one or more servers, the plurality of HRLC final land cover layers to calibrate weights for each independent variable.

4. The method of claim 3, wherein the land cover inference engine uses the same set of independent variables and the respective calibrated weights for each of the set of independent variables to predict a class for each pixel of the plurality of pixels.

5. The method of claim 1, further comprising transferring, by the one or more servers, the model to images from a geographic location where the model was not trained.

6. The method of claim 1, wherein both training and transferring the model comprises:
receiving, by the one or more servers, a first image of a scene;
receiving, by the one or more servers, a plurality of second images of the scene taken over a period of time, wherein the plurality of second images are taken at a relatively lower resolution than the first image;
performing, by the one or more servers, a plurality of transformations on the first image;
performing, by the one or more servers, a plurality of transformations on the plurality of second images; and
creating, by the one or more servers, a temporal stack layer for a plurality of temporal statistics for each of the plurality of transformations on the plurality of second images, the output land cover layer prediction comprising a plurality of classifications.

7. The method of claim 1, further comprising post processing, by the one or more servers, comprising post-classification ruleset correction (PCR) of the output land cover layer prediction.

8. The method of claim 1, further comprising post processing, by the one or more servers, comprising post-classification ruleset correction via a fuzzy classifier of the output land cover layer prediction.

9. The method of claim 8, wherein the fuzzy classifier is configured to receive fuzzy classifier inputs comprising at least one of: raw land cover from the model, NDVI and NDWI from a first image, segment clumps, P3D classification (or some buildings and roads layer), a cloud mask, and a floodplain mask; and
wherein the fuzzy classifier is configured to generate a refined land cover layer based on the fuzzy classifier inputs and based on the output land cover layer prediction.

10. The method of claim 8, wherein the fuzzy classifier performs fuzzy classification by:
testing the output land cover layer prediction using a ruleset that leverages a subset of the set of independent variables to determine if each classified pixel fails or passes the ruleset; and
wherein when the classified pixel fails the ruleset for a first layer, a second layer produced by a CNN classifier may be run through the ruleset; wherein when the classified pixel passes the ruleset with the second land cover layer, and fails the test with the first layer, the plurality of pixels from the second classification may be used in a final refined land cover layer.

11. The method of claim 7, wherein the PCR further comprises intersect object learning classification.

12. The method of claim 1, wherein the set of independent variables further comprise a source image layer.

13. The method of claim 1, further comprising:
formatting, by the one or more servers, the single image;
and delivering, by the one or more servers, the single image, whereby the single image is delivered with 14 classes at 2m resolution.

14. The method of claim 1, wherein a number of independent variables are used to train the model, wherein the number is greater than four, and wherein the model is configured to be trained without over-fitting.

15. The method of claim 6, wherein transferring the model comprises performing, by the one or more servers, a plurality of transformations including at least one of: a Normalized Difference Vegetation Index (NDVI) transformation; a Normalized Difference Wetness Index (NDWI) transformation; a Modified Soil-Adjusted Vegetation Index (MSAVI) transformation; a Tasseled Cap band 1 transformation; a Tasseled Cap band 2 transformation; a Tasseled Cap band 3 transformation;
wherein the plurality of temporal statistics comprise at least one of minimum, maximum, mean, median, standard deviation, and range; and
wherein the plurality of classifications comprise at least one of deciduous trees, evergreen trees, scrub, grass, bare, built-up/structures, agriculture dry, agriculture wet, wetland, mangrove, water, snow/ice, clouds, and other impervious surface.

16. The method of claim 1, wherein during training the model, the model is trained with inputs that simulate atmospheric degradation haze/fog.

17. The method of claim 1, wherein transferring the model further comprises running the model on a Convolutional Neural Network (“CNN”) comprising an Xunet CNN, wherein the model comprises a ‘reduced’ receptive field, a source imagery mask layer, a vector layer, “fog” data augmentations, and brightness/contrast augmentation.

18. The method of claim 1, wherein transferring the model further comprises using a high-res Digital Surface Model (“DSM”) as independent variables in a classifier, and from the high-res DSM produce a floodplain mask.

19. The method of claim 1, wherein generating HRLC outputs comprises:
receiving, by the one or more servers, a first image of a scene;
receiving, by the one or more servers, a plurality of second images of the scene taken over a period of time, wherein the plurality of second images are taken at a relatively lower resolution than the first image;
performing, by the one or more servers, segmentation on the first image; performing, by the one or more servers, a plurality of transformations on the plurality of second images; and
creating, by the one or more servers, a temporal stack layer for a plurality of temporal statistics for each of the plurality of transformations on the plurality of second images.

20. A system comprising the one or more servers and one or more databases, wherein the one or more servers are configured to perform the method of claim 1.
